(19) United States
(12) Patent Application Publication
(10) Pub. No.: US 2007/0231475 A1
(43) Pub. Date: Oct. 4, 2007

(54) Conductor structure on dielectric material

(76) Inventors: Tadanori Shimoto, Tsukuba (JP); Kinya Ichikawa, Tsukuba (JP)

Correspondence Address: INTEL CORPORATION;c/o INTELLEVATE, LLC, P.O. BOX 52050, MINNEAPOLIS, MN, 55402, US

(21) Appl. No.: 11/395,351

(22) Filed: Mar. 31, 2006

(51) Int. Cl. B41M 5/00; B05D 1/32; B05D 1/36

(52) U.S. Cl. 427/145; 427/402; 427/272

(57) ABSTRACT

In some embodiments, conductor structure on dielectric material is presented. In this regard, a substrate in introduced having a conductive paste layer to adhere to dielectric material without a micro-anchor. Other embodiments are also disclosed and claimed.

### FIELD OF THE INVENTION

Embodiments of the present invention generally relate to the field of integrated circuit packages, and, more particularly to conductor structure on dielectric material.

### BACKGROUND OF THE INVENTION

The demand for enhanced performance and body size reduction of integrated circuit components continues to increase design and fabrication complexity due to the higher bandwidth requirements needed to enable higher clock frequencies. The substrates designed for these components will need to be manufactured with even smaller feature sizes to enable optimization of bandwidth.

### BRIEF DESCRIPTION OF THE DRAWINGS

The present invention is illustrated by way of example and not limitation in the figures of the accompanying drawings in which like references indicate similar elements, and in which:

FIG. 1 is a graphical illustration of a cross-sectional view of a partially formed IC package substrate, in accordance with one example embodiment of the invention;

FIG. 2 is a graphical illustration of a cross-sectional view of a partially formed IC package substrate, in accordance with one example embodiment of the invention;

FIG. 3 is a graphical illustration of a cross-sectional view of a partially formed IC package substrate, in accordance with one example embodiment of the invention;

FIG. 4 is a flow chart of an example method for forming conductor structure on dielectric material, in accordance with one example embodiment of the invention; and

FIG. 5 is a block diagram of an example electronic appliance suitable for implementing an IC package substrate with conductor structure on dielectric material, in accordance with one example embodiment of the invention.

### DETAILED DESCRIPTION

In the following description, for purposes of explanation, numerous specific details are set forth in order to provide a thorough understanding of the invention. It will be apparent, however, to one skilled in the art that embodiments of the invention can be practiced without these specific details. In other instances, structures and devices are shown in block diagram form in order to avoid obscuring the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

FIG. 1 is a graphical illustration of a cross-sectional view of a partially formed IC package substrate, in accordance with one example embodiment of the invention. In accordance with the illustrated example embodiment, package substrate 100 includes one or more of substrate core 102, dielectric material 104, internal copper conductor 106, via hole 108, thin-film conductive paste 110, copper plating layer 112, and dielectric surface 114.

Substrate core 102 represents a substrate core that may be made of a sold metal such as copper or may comprise multiple conductive layers laminated together. Substrate core 102 may be laminated with dielectric material as part of a substrate build-up and may have insulated traces routed through it.

Dielectric material 104 represents material such as epoxy resin that has been added to substrate core 102 as part of a build-up process. Conductive traces may be routed within and through-holes may be routed through dielectric material 104. Internal copper conductor 106 is intended to represent a conductive trace embedded within dielectric material 104.

Via hole 108 represents where dielectric material 104 was removed from dielectric surface 114 to expose internal copper conductor 106. Via hole 108 may be formed by any method known in the art.

Thin-film conductive paste 110 provides metallizing adhesion with dielectric material 104. Thin-film conductive paste 110 comprises copper particles and adhesives such as epoxy, polymide, or silicon-type binder. In one embodiment, thin-film conductive paste 110 comprises copper particles with a diameter of between about 1 and 100 nanometers. In one embodiment, thin-film conductive paste 110 comprises a thickness of between about 0.05 and 2.0 micrometers. In one embodiment, thin-film conductive paste 110 comprises about 30% by weight or less of adhesives.

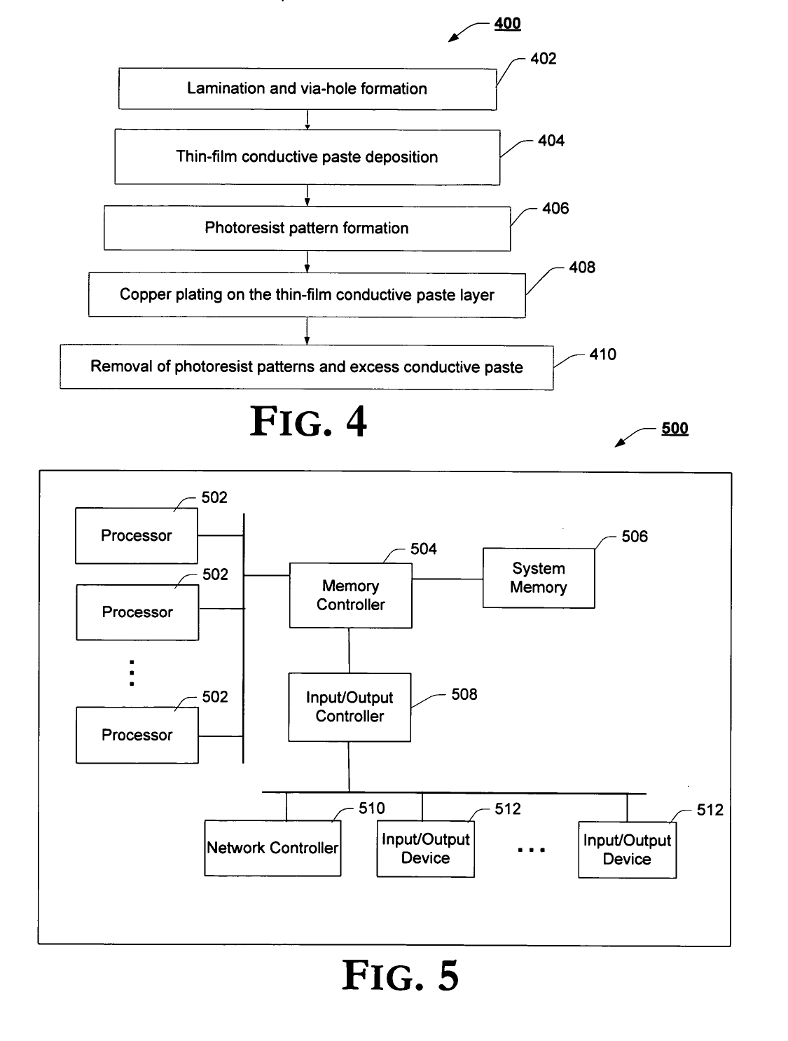

As part of a process for forming conductor structure on dielectric material, for example as described in reference to FIG. 4, copper plating layer 112 is formed on thin-film conductive paste 110. In one embodiment, copper plating layer 112 is formed by electroplating after photoresist patterning. In one embodiment, copper plating layer 112 is formed by electro-less plating. In one embodiment, copper plating layer 112 includes wiring lines with a pitch of less than about 30 micrometers.

Dielectric surface 114 may have a surface roughness Ra of less than about 0.1 micrometers. Thin-film conductive paste 110 eliminates the need to chemically treat dielectric surface 114, such as KMnO4 wet treatment, to form a micro-anchor. One skilled in the art would appreciate that micro-anchor formation may not be environmentally friendly.

In one embodiment, package substrate 100 is coupled with an integrated circuit die such as a flip chip silicon die. In another embodiment, package substrate 100 is laminated with another dielectric layer as part of a continued build-up process.

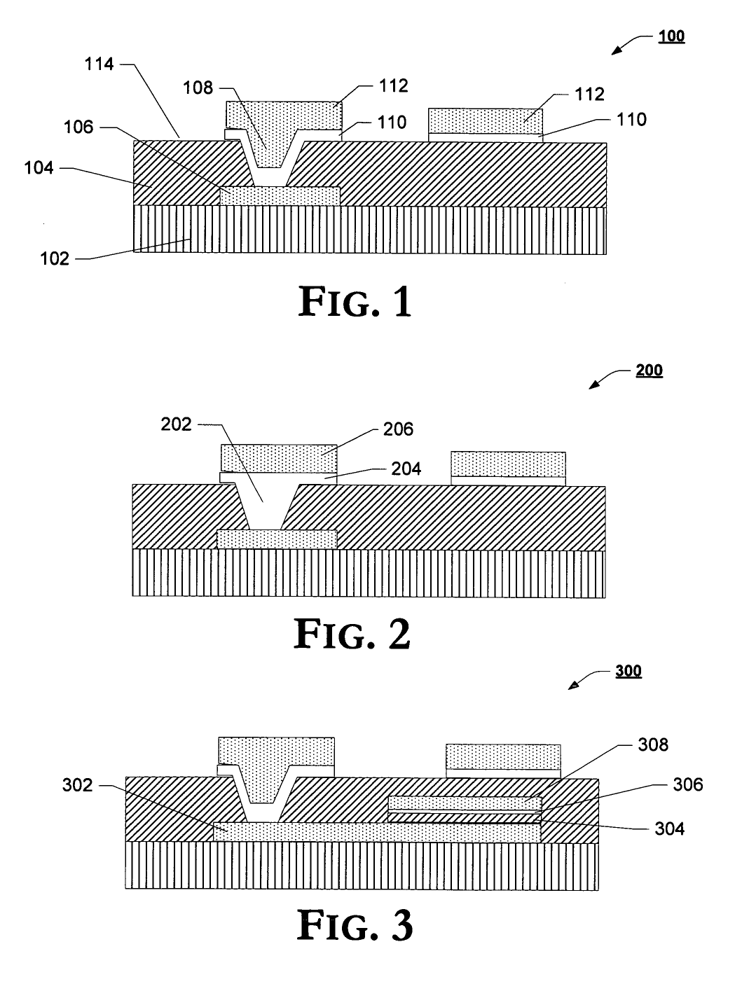

FIG. 2 is a graphical illustration of a cross-sectional view of a partially formed IC package substrate, in accordance with one example embodiment of the invention. As shown, package substrate 200 includes via hole 202, conductive paste 204 and copper plating layer 206. In this embodiment, via hole 202 has been filled with conductive paste 204 in order to obtain higher photoresist resolution.

FIG. 3 is a graphical illustration of a cross-sectional view of a partially formed IC package substrate, in accordance with one example embodiment of the invention. As shown, package substrate 300 includes internal copper conductor 302, thin dielectric layer 304, conductive paste layer 306 and upper conductor 308. One skilled in the art would appreciate that forming a thin film capacitor with the use of conductive paste layer 306 can provide good electrical performance with little capacity variation because upper conductor 308 is formed on thin dielectric layer 304 without a micro-anchor.

FIG. 4 is a flow chart of an example method for forming conductor structure on dielectric material, in accordance with one example embodiment of the invention. It will be readily apparent to those of ordinary skill in the art that although the following operations may be described as a sequential process, many of the operations may in fact be performed in parallel or concurrently. In addition, the order of the operations may be re-arranged or steps may be repeated without departing from the spirit of embodiments of the invention.

According to but one example implementation, the method of FIG. 4 begins with lamination (402) of dielectric material 104 on substrate core 102 (and conductor 106) and via-hole 108 formation.

Next, thin-film conductive paste 110 is deposited (404) on dielectric material 104. In one embodiment, thin-film conductive paste 110 substantially covers dielectric surface 114 and contacts conductor 106.

Next, photoresist patterns are formed (406) on the thin-film conductive paste 110. In one embodiment, an additional printing process in employed to fill via holes (for example 202) with conductive paste before photoresist patterning.

Copper plating layer 112 is then formed (408) on thin-film conductive paste layer 110. In one embodiment, the plating is done by an electroplating method.

Lastly, photoresist patterns and the associated portions of the conductive paste layer are removed (410). In one embodiment, a wet process is utilized to remove the photoresist layer. In one embodiment, a wet etching method is performed to remove the excess conductive paste. Additional steps may be needed to complete the substrate and to couple the substrate with an integrated circuit die.

FIG. 5 is a block diagram of an example electronic appliance suitable for implementing an IC package substrate with conductor structure on dielectric material, in accordance with one example embodiment of the invention. Electronic appliance 500 is intended to represent any of a wide variety of traditional and non-traditional electronic appliances, laptops, desktops, cell phones, wireless communication subscriber units, wireless communication telephony infrastructure elements, personal digital assistants, set-top boxes, or any electric appliance that would benefit from the teachings of the present invention. In accordance with the illustrated example embodiment, electronic appliance 500 may include one or more of processor(s) 502, memory controller 504, system memory 506, input/output controller 508, network controller 510, and input/output device(s) 512 coupled as shown in FIG. 5. Processor(s) 502, or other integrated circuit components of electronic appliance 500, may be housed in a package including a substrate described previously as an embodiment of the present invention.

Processor(s) 502 may represent any of a wide variety of control logic including, but not limited to one or more of a microprocessor, a programmable logic device (PLD), programmable logic array (PLA), application specific integrated circuit (ASIC), a microcontroller, and the like, although the present invention is not limited in this respect. In one embodiment, processors(s) 502 are Intel® compatible processors. Processor(s) 502 may have an instruction set containing a plurality of machine level instructions that may be invoked, for example by an application or operating system.

Memory controller 504 may represent any type of chipset or control logic that interfaces system memory 508 with the other components of electronic appliance 500. In one embodiment, the connection between processor(s) 502 and memory controller 504 may be referred to as a front-side bus. In another embodiment, memory controller 504 may be referred to as a north bridge.

System memory 506 may represent any type of memory device(s) used to store data and instructions that may have been or will be used by processor(s) 502. Typically, though the invention is not limited in this respect, system memory 506 will consist of dynamic random access memory (DRAM). In one embodiment, system memory 506 may consist of Rambus DRAM (RDRAM). In another embodiment, system memory 506 may consist of double data rate synchronous DRAM (DDRSDRAM).

Input/output (I/O) controller 508 may represent any type of chipset or control logic that interfaces I/O device(s) 512 with the other components of electronic appliance 500. In one embodiment, I/O controller 508 may be referred to as a south bridge. In another embodiment, I/O controller 508 may comply with the Peripheral Component Interconnect (PCI) Express™ Base Specification, Revision 1.0a, PCI Special Interest Group, released Apr. 15, 2003.

Network controller 510 may represent any type of device that allows electronic appliance 500 to communicate with other electronic appliances or devices. In one embodiment, network controller 510 may comply with a The Institute of Electrical and Electronics Engineers, Inc. (IEEE) 802.11b standard (approved Sep. 16, 1999, supplement to ANSI/IEEE Std 802.11, 1999 Edition). In another embodiment, network controller 510 may be an Ethernet network interface card.

Input/output (I/O) device(s) 512 may represent any type of device, peripheral or component that provides input to or processes output from electronic appliance 500.

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

Many of the methods are described in their most basic form but operations can be added to or deleted from any of the methods and information can be added or subtracted from any of the described messages without departing from the basic scope of the present invention. Any number of variations of the inventive concept is anticipated within the scope and spirit of the present invention. In this regard, the particular illustrated example embodiments are not provided to limit the invention but merely to illustrate it. Thus, the scope of the present invention is not to be determined by the specific examples provided above but only by the plain language of the following claims.

What is claimed is:

1. An integrated circuit chip package substrate comprising:
a dielectric layer which has not been treated to form a micro-anchor;
a conductive paste layer on the dielectric layer; and
a copper plating layer on the conductive paste layer.

2. The integrated circuit chip package substrate of claim 1, further comprising a copper conductor within the dielectric material coupled with the conductive paste layer.

3. The integrated circuit chip package substrate of claim 2, further comprising a capacitor including a second conductive paste layer embedded in the dielectric material.

4. The integrated circuit chip package substrate of claim 1, further comprising via holes in the dielectric layer substantially filled with conductive paste.

5. The integrated circuit chip package substrate of claim 1, wherein the conductive paste layer comprises copper particles with a diameter of between about 1 and 100 nanometers.

6. The integrated circuit chip package substrate of claim 1, wherein the conductive paste layer comprises a thickness of between about 0.05 and 2.0 micrometers.

7. The integrated circuit chip package substrate of claim 1, wherein the conductive paste layer comprises about 30% by weight or less of adhesives.

8. An apparatus comprising:
an integrated circuit die; and
a substrate, including a dielectric layer, a conductive paste layer, and a copper plating layer, wherein the dielectric layer has a surface roughness Ra of less than about 0.1 micrometers, wherein the conductive paste layer includes adhesives and copper particles, wherein the copper plating layer includes wiring lines with a pitch of less than about 30 micrometers.

9. The apparatus of claim 8, further comprising:
a via hole in the substrate through which copper embedded in the dielectric layer is in contact with the conductive paste layer, wherein the conductive paste layer is in contact with the copper plating layer.

10. The apparatus of claim 9, wherein the via hole is substantially filled with the conductive paste layer.

11. The apparatus of claim 8, further comprising a capacitor within the dielectric material, wherein the capacitor comprises two copper layers, a dielectric layer, and a conductive paste layer.

12. An electronic appliance comprising:
a network controller;
a system memory; and
a processor, wherein the processor includes a substrate, including a dielectric layer, a conductive paste layer, and a copper plating layer, wherein the dielectric layer includes a copper conductor, wherein the conductive paste layer adheres to the dielectric layer, wherein the copper plating layer is formed on the conductive paste layer and includes wiring lines with a pitch of less than about 30 micrometers.

13. The electronic appliance of claim 12, wherein the conductive paste layer comprises copper particles with a diameter of between about 1 and 100 nanometers.

14. The electronic appliance of claim 12, wherein the conductive paste layer comprises a thickness of between about 0.05 and 2.0 micrometers.

15. The electronic appliance of claim 12, wherein the conductive paste layer comprises about 30% by weight or less of adhesives.

16. A method comprising:
depositing a thin-film conductive paste on a surface of a laminated substrate core without a micro-anchor; and
forming copper plating including wiring lines with a pitch of less than about 30 micrometers on the thin-film conductive paste layer.

17. The method of claim 16, forming via holes to expose copper under a dielectric layer surface.

18. The method of claim 16, further comprising filling via holes with conductive paste.

19. The method of claim 16, wherein the copper plating is formed through photoresist patterning and electroplating.

20. The method of claim 16, further comprising attaching an integrated circuit die to the substrate.
